(19) United States
(12) Patent Application Publication
(10) Pub. No.: US 2023/0354298 A1
(43) Pub. Date: Nov. 2, 2023

(54) TRAFFIC INDICATION IN MULTI-LINK OPERATION

(71) Applicant: QUALCOMM Incorporated, San Diego, CA (US)

(72) Inventors: Gyanranjan HAZARIKA, Santa Clara, CA (US); Krishna Chaitanya RAO, Bangalore (IN); Abhishek Pramod PATIL, San Diego, CA (US); Kiran VENKATAPPA, Bangalore (IN); Sandip HOMCHAUDHURI, San Jose, CA (US); Srinivas PITLA, Fremont, CA (US); Shashikala Baila PRABHU, Mangalore (IN); Krishnakumar MUTHUSAMY, Cupertino, CA (US)

(21) Appl. No.: 17/661,218

(22) Filed: Apr. 28, 2022

(51) Int. Cl. H04W 72/12

(52) U.S. Cl. CPC H04W 72/121; H04W 72/1278

(57) ABSTRACT

This disclosure provides methods, devices and systems for reducing beacon bloat, inefficient spectrum use, and coupling of multi-link transmission element (MLTE) with a traffic indication map (TIM) element. In certain aspects, an MLTE may be transmitted by an access point (AP) multi-link device (MLD) in a frame separate from the beacon frame to reduce the size of the beacon frame. In such an example, the beacon frame may provide an indication to a non-AP MLD that is should remain awake to receive data. In certain aspects, the AP may transmit multiple MLTEs to reduce the amount of bandwidth used for MLTE transmission by cutting out non-AP MLDs and other stations (STAs) that do not have buffered data. In certain aspects, the AP may assign each non-AP MLD capable of transmission identifier (TID)-to-link mapping (TID2LM) with a per-link traffic indication bitmap (PLTIB) to decouple the MLTE from the TIM element.

### TECHNICAL FIELD

This disclosure relates generally to wireless communication, and more specifically, addressing with traffic identifier to link mapping (TID2LM).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN. Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which may be referred to as data units. Devices may transmit control information in order to better facilitate communication between the devices. However, such information may increase overhead and reduce efficiency. Accordingly, there is a need for improved methods and devices for communicating such information between devices.

### SUMMARY

The systems, methods and devices of this disclosure each have several innovative aspects, no single one of which is solely responsible for the desirable attributes disclosed herein.

In certain aspects, the disclosure is directed to an apparatus for wireless communications. The apparatus may include a memory comprising instructions and one or more processors configured to execute the instructions. In some examples, the apparatus may be configured to generate an identifier corresponding to a first non-access point (AP) multi-link device (MLD), and a first traffic element comprising an indication of a first offset value. In some examples, the apparatus may be configured to output, for transmission to the first non-AP MLD, the first traffic element and an indication of the identifier. In some examples, the apparatus may be configured to output, for transmission to the first non-AP MLD, data stored in a first bufferable unit (BU).

In certain aspects, the disclosure is directed to an apparatus for wireless communications. The apparatus may include a memory comprising instructions and one or more processors configured to execute the instructions. In some examples, the apparatus may be configured to obtain, from an access point (AP) multi-link device (MLD), an identifier and a first traffic element comprising an indication of a first offset value. In some examples, the apparatus may be configured to identify a first link based on a mapping between the first offset value and the identifier. In some examples, the apparatus may be configured to obtain, via the first link, data stored in a first bufferable unit (BU).

In certain aspects, the disclosure is directed to a method for wireless communications by an access point (AP) multi-link device (MLD). In some examples, the method includes generating an identifier corresponding to a first non-AP MLD, and a first traffic element comprising an indication of a first offset value. In certain aspects, the method includes outputting, for transmission to the first non-AP MLD, the first traffic element and an indication of the identifier. In certain aspects, the method includes outputting, for transmission to the first non-AP MLD, data stored in a first bufferable unit (BU).

In certain aspects, the disclosure is directed to a method for wireless communications by a non-access point (AP) multi-link device (MLD). In some examples, the method includes obtaining, from an AP MLD, an identifier and a first traffic element comprising an indication of a first offset value. In some examples, the method includes identifying a first link based on a mapping between the first offset value and the identifier. In certain aspects, the method includes obtaining, via the first link, data stored in a first bufferable unit (BU).

In certain aspects, the disclosure is directed to an apparatus for wireless communications. In some examples, the apparatus includes means for generating an identifier corresponding to a first non-access point (AP) multi-link device (MLD), and a first traffic element comprising an indication of a first offset value. In certain aspects, the apparatus includes means for outputting, for transmission to the first non-AP MLD, the first traffic element and an indication of the identifier. In certain aspects, the apparatus includes means for outputting, for transmission to the first non-AP MLD, data stored in a first bufferable unit (BU).

In certain aspects, the disclosure is directed to an apparatus for wireless communications. In some examples, the apparatus includes means for obtaining, from an access point (AP) multi-link device (MLD), an identifier and a first traffic element comprising an indication of a first offset value. In some examples, the apparatus includes means for identifying a first link based on a mapping between the first offset value and the identifier. In certain aspects, the apparatus includes means for obtaining, via the first link, data stored in a first bufferable unit (B U).

In certain aspects, the disclosure is directed to a non-transitory computer-readable medium having instructions stored thereon that, when executed by an apparatus, cause the apparatus to perform operations including generating an identifier corresponding to a first non-access point (AP) multi-link device (MLD), and a first traffic element comprising an indication of a first offset value. In certain aspects, the operations include outputting, for transmission to the first non-AP MLD, the first traffic element and an indication of the identifier. In certain aspects, the operations include outputting, for transmission to the first non-AP MLD, data stored in a first bufferable unit (BU).

In certain aspects, the disclosure is directed to a non-transitory computer-readable medium having instructions stored thereon that, when executed by an apparatus, cause the apparatus to perform operations including obtaining, from an access point (AP) multi-link device (MLD), an identifier and a first traffic element comprising an indication of a first offset value. In some examples, the operations include identifying a first link based on a mapping between the first offset value and the identifier. In certain aspects, the operations include obtaining, via the first link, data stored in a first bufferable unit (BU).

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 is a pictorial diagram illustrating an example wireless communication network.

FIG. 2 is a diagram illustrating hardware aspects of an access point and two stations.

FIG. 3 is an example of a multi-link traffic element (MLTE) construction.

FIG. 4 is a schematic illustrating a conceptual time-based illustration of an example MLTE transmitted in a frame separate from a beacon frame used to transmit a traffic indication map (TIM) element.

FIGS. 5A and 5B are block diagrams illustrating a basic multi-link element format with a common information subfield, and an MLTE with a non-legacy subfield.

FIGS. 6A-6D are block diagrams illustrating example per-link traffic indication bitmap (PLTIB) layouts.

FIG. 7 is a block diagram illustrating a non-legacy element comprising a tuple bitmap that maps to the MLTE with the non-legacy subfield.

FIG. 8 is a flow diagram illustrating example operations for wireless communication, in accordance with certain aspects of the present disclosure.

FIG. 9 illustrates a communications device that may include various components (e.g., corresponding to means-plus-function components) configured to perform operations for the techniques disclosed herein.

FIG. 10 is a flow diagram illustrating example operations for wireless communication, in accordance with certain aspects of the present disclosure.

FIG. 11 illustrates a communications device that may include various components (e.g., corresponding to means-plus-function components) configured to perform operations for the techniques disclosed herein.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU)-MIMO. The described implementations also can be implemented using other wireless communication protocols or RF signals suitable for use in one or more of a wireless personal area network (WPAN), a wireless local area network (WLAN), a wireless wide area network (WWAN), or an Internet of things (IOT) network.

Signaling refers to control fields or information that can be used by a wireless communication device to interpret another field or portion of a packet. For some wireless communication techniques, such as orthogonal frequency division multiple access (OFDMA), a wireless channel may utilize multiple subchannels that can be divided or grouped in a transmission to form different resource units (RUs). The signaling can indicate which RUs include data for a particular recipient. Additionally or alternatively, signaling may be required for multiple-user (MU) multiple-input multiple-output wireless communications. Other types of signaling include indicators regarding which subchannels carry further signaling or which subchannels are punctured. Still further, some signaling can indicate the lengths of one or more fields or subfields in the data packet. As new wireless communication protocols enable enhanced features, new preamble designs are needed to support signaling regarding the new features and packet formats.

Traffic identifier (TID)-to-link mapping (TID2LM) is a IEEE 802.11be concept where specific TIDs can be mapped to specific links for communications between a non-access point (AP) multi-link device (MLD) (e.g., a station (STA)) and an AP MLD in associated state. In some examples, TID2LM operations leverage availability of multiple links to provide relatively more efficient wireless communications. TID2LM operations use, in part, two communication elements: a TID2LM element and a multi-link traffic element (MLTE). Generally, the TID2LM element is configured to setup a TID2LM of certain TIDs to certain links for the STA, and both of a traffic indication map (TIM) element and the MLTE are configured to signal the availability of data intended for the STA stored in a buffer unit (BU) on one or more links.

The MLTE defines a series of per-link traffic indication bitmaps (PLTIBs) within a per-link traffic indication field (PLTIF). A STA receiving an MLTE from an AP can find a bitmap corresponding to it using a tuple of an association identifier (AID)-offset k and the STA's own AID. The position of the AID of the STA corresponding to AID-offset k will define the position of a bitmap corresponding to the STA in the PLTIF.

An AP may assign AIDs to STAs during initial association, but assigning an AID using a first-come first-serve (FCFS) basis (e.g., assigning a next available AID to whichever STA connects first, regardless of whether the STA is a legacy device or an MLD) may lead to inefficient use of MLTE and may contribute to beacon bloat and inefficient spectrum use (e.g., resource heavy beacon frames with redundant and/or useless information). For example, the AP must include a redundant PLTIB in PLTIF for each legacy STA the AID of which appears after AID-offset k in the PVB.

Conventionally, up to 15 links may be allowed per PLTIB. Thus, multiple MLTEs may be required when the number of links increases and a requirement of signaling data available for transmission on a BU for several clients arise at the same time. Accordingly, one MLTE can support up to 504 STAs in a 3-link AP scenario. If some of the STAs are legacy, then the space available for STAs that are MLD is reduced. As such, the MLTE may grow larger due to redundant PLTIB entries, which contributes to beacon bloat and less efficient use of spectrum given the lower rates at which beacons are transmitted.

Moreover, wireless communications may be improved by avoiding coupling of a TIM element with an MLTE. Associating MLTE with TIM may require certain TIM resources to organize PLTIBs of the MLTE, thereby potentially causing redundancies and reducing AP-product scalability. In some examples, there may be a limited number of bits available in a partial virtual bitmap of the TIM element. With a 4-bit link ID field, an AP MLD may support up to 16 links. In theory there may be up to 255 virtual APs. However, in practice, it is common to see up to 16 basic service set identifiers (BSSIDs) in a multiple BSSID set.

Accordingly, aspects of the present disclosure are directed to techniques and methods for reducing beacon bloat and inefficient spectrum use, and also reducing or eliminating coupling of the MLTE with TIM.

In a first example, a separate frame may be used to carry an MLTE, wherein the MLTE frame is separate from a beacon frame that carries a TIM (in which its corresponding partial virtual bitmap (PVB) is set). The separate frame may be group addressed and transmitted subsequent to the TIM carrying beacon frame. The separate frame may be any suitable existing frame or a new frame. After receiving the TIM and learning that the AP has data stored on a BU for the STA, the STA may remain awake to receive this subsequent frame following the beacon frame. The PVB of the beacon frame or any other suitable indication may alert the STA to monitor the medium for the subsequent frame carrying the MLTE.

In certain aspects, the separate frame carrying the MLTE may be a downlink (DL) multi-user (MU) physical layer convergence procedure (PLCP) protocol data unit (PPDU). In some examples, the DL MU PPDU may include a plurality of resource units (RUs) wherein one or more of the RUs carry an MLTE. In some examples, a plurality of STAs may be grouped into multiple groups, wherein each group corresponds to an RU. In this way, each STA may wait for its corresponding RU to receive the MLTE. Accordingly, the amount of resources used by the beacon frame may be reduced, and if each STA is aware of its corresponding RU, the STA may stop listening and decoding AP transmissions (e.g., sleep) then wake up to receive the MLTE of its corresponding RU.

In a second example, the AP may transmit multiple MLTEs with different AID-offsets so that each MLTE is smaller in size (e.g., carries fewer multi-link traffic bitmaps (PLTIFs). In this example, the AP may transmit the MLTEs over the beacon frame carrying the TIM, or in a separate frame. Multiple MLTEs may reduce beacon bloat and improve spectrum use by targeting only MLD STAs, thereby using fewer resources to provide multilink traffic indication bitmaps to STAs that aren't configured for TID2LM.

In a third example, the AP may use a PLTIB-ID (e.g., instead of an AID) to indicate to TID2LM configured STAs that the AP has data in a BU for transmission. In this example, the AP may assign a PLTIB-ID to each TID2LM configured STA during association with the AP. The AP may transmit the PLTIB-ID to the STA via a common information field of a basic multi-link element, or any other suitable element. The presence of the PLTIB ID in the common information field may be indicated by a bit (e.g., B5) in a presence bitmap subfield of the multi-link element. The MLTE may be modified to include a PLTIB-ID offset field instead of an AID offset field. Thus, a TID2LM capable STA can find its relevant bitmap in the PLTIF using the tuple of PLTIB-ID offset k carried in the same element and its own PLTIB-ID. The position of the PLTIB ID of that STA pertaining to offset k may define the position of the relevant bitmap in the PLTIF. In some examples, holes in the PLTIF may be resolved with a new (e.g., non-legacy) element configured to carry the tuple and the bitmap. By providing one or more tuples, the AP may notify only the TID2LM capable STAs that have data intended for them stored in a BU. As such, the third example may decouple the PLTIB from the TIM AID-space.

As used herein, the term “non-legacy” may refer to operations or aspects that fall outside of the accepted 802.11 standards currently published and officially recognized. Thus, many if not all 802.11 capable wireless communication devices currently in operation may not be configured to communicate using the non-legacy aspects described herein. For example, a non-legacy subfield may include a bits that currently exists in a frame but carry a different set of data relative to the legacy subfield.

In addition to traffic indication of individually addressed buffered units (BUs), the disclosure is directed to mechanisms that provide cross-link traffic indication for group addressed BUs that are buffered at other APs which are affiliated with the same AP MLD as that of the transmitting AP. In order to provide such cross-link indication, the AP MLD may reserve one or more bits in the TIM element. In scenarios that involve multiple BSSID sets and multiple links, the AP MLD may set aside several bits. Therefore, a relatively large number of bits in the TIM element may be consumed for signaling group addresses for other links of the AP MLDs corresponding to each AP in a multiple BSSID set, resulting in inefficient use of the partial virtual bitmap.

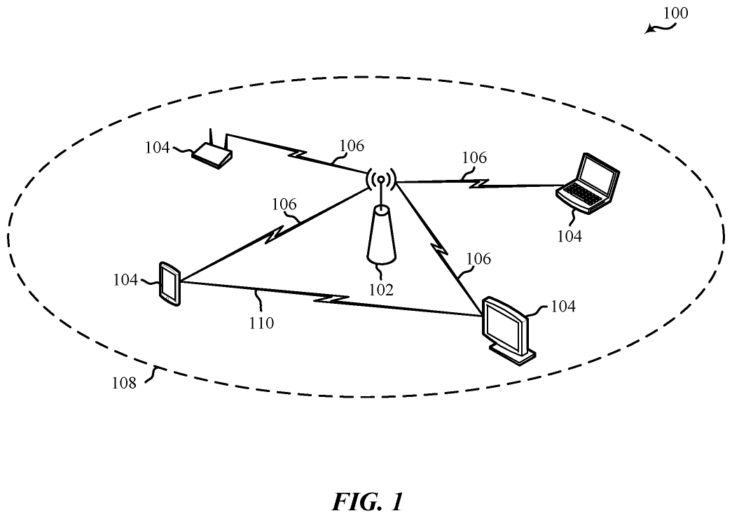

FIG. 1 is a network schematic illustrating an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN network 100 also can include multiple APs 102 (e.g., multiple APs that are part of an AP multi-link device (MLD)).

Certain aspects of the disclosure may relate to multi-link (ML) communications between wireless MLDs. Each MLD may have a unique medium access control (MAC) address, which is also referred to as a MAC service access point (MAC-SAP) endpoint. One example of an MLD device is an AP MLD 102, which includes multiple APs each capable of communicating on multiple communication links and establishing a basic service set (BSS) on the multiple communication links. Another example of an MLD device is a STA MLD 104 (e.g., a non-AP MLD), which includes multiple STAs capable of communicating with other devices (such as an AP MLD 102) on multiple communication links. The STA MLD 104 may have one medium access control physical layer (MAC-PHY) instance for each of the multiple communication links, and the MAC address of each MAC-PHY instance may be the same or different.

Each of the STAs 104 also may be referred to as a mobile station (MS), a mobile device, a mobile handset, a wireless handset, an access terminal (AT), a user equipment (UE), a subscriber station (SS), a non-AP MLD, or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple subchannels or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

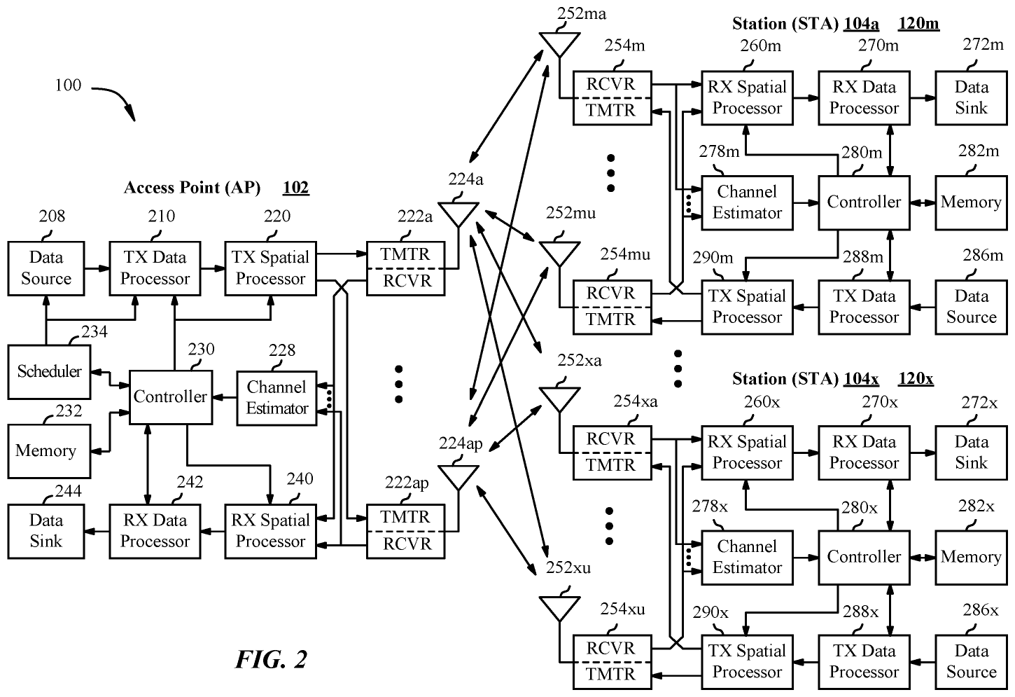

FIG. 2 illustrates a block diagram of an AP 102 and two STAs 104a and 104x in a BSS. The AP 102 is equipped with Nₜ antennas 224a through 224t. STA 120m is equipped with N_{ut,m} antennas 252ma through 252mu, and STA 120x is equipped with N_{ut,x} antennas 252xa through 252xu. The AP 102 is a transmitting entity for the downlink and a receiving entity for the uplink. Each STA 104 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and Nan may be static values or can change for each scheduling interval. The beam-steering or some other spatial processing technique may be used at the access point and user terminal.

On the uplink, at each STA 104 selected for uplink transmission, a transmit (TX) data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the AP 102.

Nᵤₚ STAs may be scheduled for simultaneous transmission on the uplink. Each of these STAs performs spatial processing on its data symbol stream and transmits its set of transmit symbol streams on the uplink to the AP 102.

At the AP 102, Nₐₚ antennas 224a through 224ap receive the uplink signals from all Nᵤₚ STAs transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective STA. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at AP 102, a TX data processor 210 receives traffic data from a data source 208 for Nan STA scheduled for downlink transmission, control data from a controller 230, and possibly other data from a scheduler 234. The various types of data may be sent on different transport channels. TX data processor 210 processes (e.g., encodes, interleaves, and modulates) the traffic data for each STA based on the rate selected for that STA. TX data processor 210 provides Nan downlink data symbol streams for the N_{dn} STA. A TX spatial processor 220 performs spatial processing (such as a precoding or beamforming, as described in the present disclosure) on the Nan downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the STA.

At each STA 120, N_{ut,m} antennas 252 receive the Nₐₚ downlink signals from AP 102. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the STA. The receiver spatial processing is performed in accordance with the CCMI, MMSE or some other technique. An RX data processor 270 processes (e.g., demodulates, deinterleaves and decodes) the recovered downlink data symbol stream to obtain decoded data for the STA.

At each STA 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each STA typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each STA may send feedback information (e.g., the downlink and/or uplink eigenvectors, eigenvalues, SNR estimates, and so on) to the access point. Controllers 230 and 280 also control the operation of various processing units at AP 102 and STA 104, respectively.

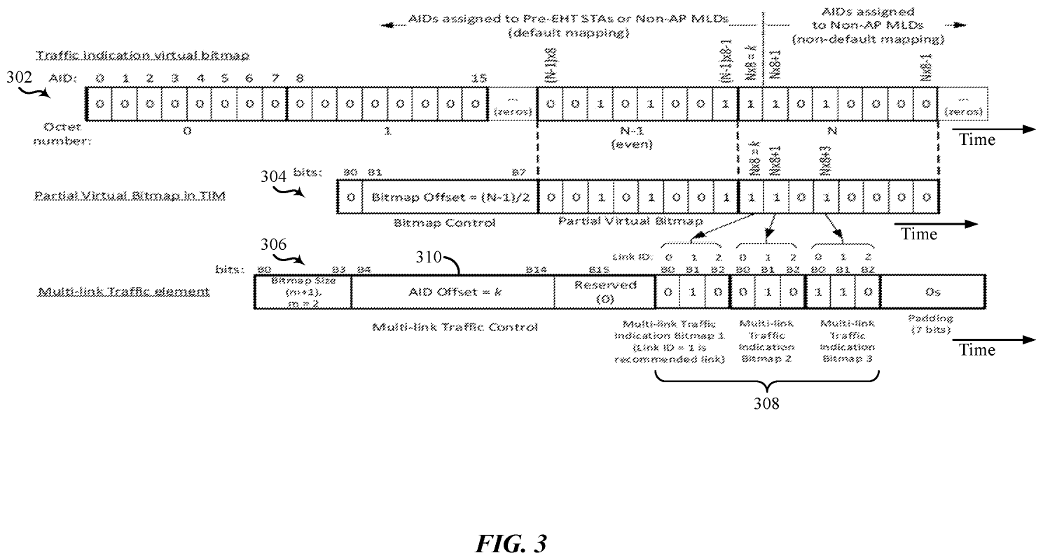

FIG. 3 is a block diagram of an example multi-link traffic element (MLTE) construction. Here, a first row 302 of bits illustrates an example association identifier (AID) space. When STAs associate with an AP, the AP may assign an AID to each of the STAs. AID values may range from 1 through 2,007.

A second row 304 illustrates a partial virtual bitmap (PVB) in a traffic indication map (TIM) element. The TIM element is a structure used in 802.11 network management frames (e.g., beacon frame). The TIM element may contain four fields: a delivery TIM (DTIM) count (not shown), a DTIM period (not shown), a bitmap control, and PVB. A third row 306 illustrates an MLTE comprising five fields: a bitmap size, an AID offset, a reserved field, multiple bitmap fields, and a padding field.

In some examples, an AP may be affiliated with an AP MLD, where that AP is not associated with a multiple basic service set identifier (MBSSID) may indicate pending traffic (e.g., data buffered at the AP) for a non-AP MLD (e.g., STA) associated with that AP MLD using the PVB of the TIM element. For example, the AP may set a bit of the PVB corresponding to an AID value assigned to the non-AP MLD.

Similarly, an AP affiliated with an AP MLD where the AP corresponds to a transmitted BSSID in a multiple BSSID set may indicate pending buffered traffic for a non-AP MLD associated with any AP MLD that has an affiliated AP in the same multiple BSSID set as the AP using the PVB.

An AP affiliated (e.g., associated) with an AP MLD may transmit an MLTE in a Beacon frame it transmits if at least one of the associated non-AP MLD has successfully negotiated TID2LM with the AP MLD for DL or bidirectional traffic and the AP MLD has data buffered in one or more BUs for the non-AP MLD. As illustrated, the MLTE includes multiple per-link traffic indication bitmap (PLTIB) subfields in a per-link traffic indication bitmap list field (e.g., PLTIF 308). Each PLTIB subfield may correspond to an AID of a non-AP MLD or STA, starting from the bit number k of the PVB. The AID offset 310 subfield of the multi-link traffic control field of the MLTE may include the k value. The order of the PLTIB subfield(s) may follow the order of the bits that are set to 1 in the PVB subfield of the TIM element that corresponds to the AID(s) of non-AP MLD(s) or STA(s). If a non-AP MLD has successfully negotiated a TID2LM with an AP MLD with a nondefault mapping, then a bit position i of the PLTIB subfield that corresponds to the link with a link ID equal to i may be set to 1 if the AP MLD has data intended for the non-AP MLD buffered at a BU with TID(s) that are mapped to that link. Otherwise the bit may be set to 0. If a non-AP MLD is in a default mapping mode (e.g., wherein a TID is mapped to all available links), the bit position i of the PLTIB subfield that corresponds to the link with the link ID equal to i on which an STA affiliated with the non-AP MLD is operating may be set to 1 to indicate to the non-AP MLD a link on which data buffered in a BU may be received.

However, as discussed above, the AID space may be relatively large, resulting in non-AP MLDs (e.g., STAs) that are TID2LM capable being spread out across the AID spectrum. As such, a first AID associated with a first non-AP MLD may be separated in the AID space from a second AID associated with a non-AP MLD by a large number of non-TID2LM capable STAs associated with AIDs falling between the first AID and the second AID. As such, even if the AID offset of the MLTE starts at the bitmap associated with the first AID, the MLTE will have to include a bitmap for every AID between the first AID and the second AID, resulting in a bloated MLTE. Because the MLTE is carried by a beacon probe, the beacon probe will similarly be bloated. Moreover, such a configuration is not an efficient use of the wireless spectrum because the bitmaps for every AID between the first AID and the second AID will result in wasted resources.

In some examples, there are limited number of bits in the PVB of TIM element. With a 4-bit link ID field, an AP MLD can have up to 16 links. Thus, while it appears that there can be up to 255 virtual APs, there are generally up to 16 BSSIDs in a multiple BSSID set. Therefore, a large number of bits in the TIM element may be consumed to signal group addressed data for other links of the AP MLDs corresponding to each AP in a multiple BSSID set. Such an assignment of bits from PVB of TIM element should be avoided.

### Example Techniques for Reducing Beacon Size

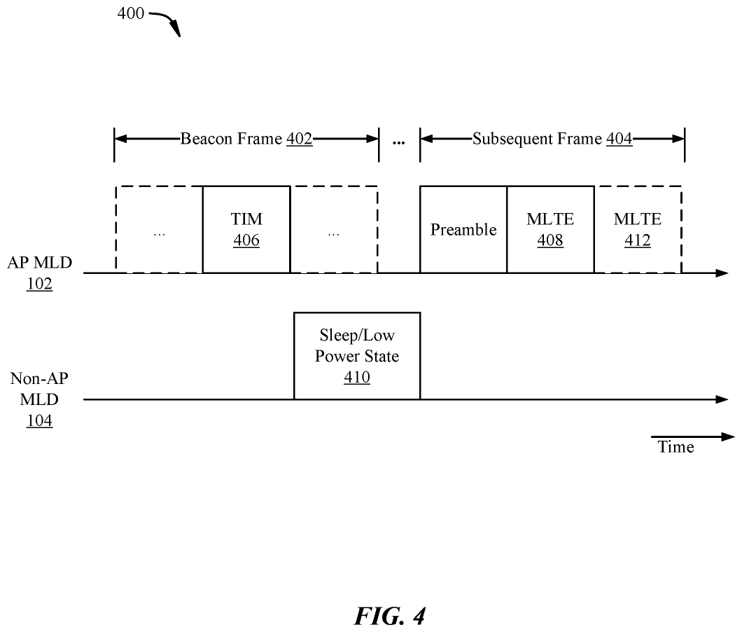

FIG. 4 is a block diagram conceptually illustrating transmissions 400 of an AP MLD (e.g., AP MLD of FIG. 1). In this example, the AP MLD 102 may first transmit a beacon frame 402 containing multiple traffic elements including a TIM element 406. As illustrated in the second row 304 of FIG. 3, a TIM element may include one or more PVBs configured to notify a non-AP MLD 104 receiving the TIM element whether the AP MLD 102 has data stored in a buffer unit to transmit to the non-AP MLD 104. For example, in some systems, if a bit corresponding to the AID associated with a particular non-AP MLD 104 is set to 1 in the PVB, then the non-AP MLD 104 may expect to receive an MLTE configured to identify a link by which the non-AP MLD 104 may retrieve the buffered data. Thus, the AP MLD 102 may broadcast a TIM element 406 to provide a non-AP MLD 104 and/or one or more STAs with an indication of whether the AP MLD 102 has buffered data.

Conventionally, the AP MLD 102 may transmit both the TIM element 406 and the corresponding MLTE in the same beacon frame 402. However, in the example of FIG. 4, the AP MLD 102 transmits an MLTE 408 corresponding to the TIM 406 in a subsequent frame 404 (e.g., transmitted after the beacon frame). The subsequent frame 404 may include multiple traffic elements, including the MLTE 408, and may be transmitted immediately after transmission of the beacon frame ends, or sometime after. As such, the non-AP MLD 104 may stop processing any remaining information provided in the beacon frame 402 once it determines (from the TIM element 406) that it can expect an MLTE 408 in the subsequent frame 404 after the beacon 402. In some examples, the non-AP MLD may enter into a sleep or low power state 410 (e.g., end processing of received beacon frame 402 signaling) for the remaining duration of the beacon frame 402 and wake up to receive the MLTE 408. Once the non-AP MLD 104 receives the MLTE 408, it may determine which link it can use to receive the buffered data and wake up on that link to receive the data. In some examples, the TIM element 406, or any suitable field in the beacon frame 402, may include an indication of whether the MLTE 408 will be transmitted in the subsequent frame 404.

As discussed, an MLTE may become a relatively long element if there are a large number of AIDs associated with non-AP MLDs or STAs that are not TID2LM capable separating two TID2LM capable non-AP MLDs. Thus, in certain aspects, the AP MLD 102 may transmit multiple MLTEs (e.g., first MLTE 408 and an optional second MLTE 412) to cut out multi-link traffic bitmaps corresponding to the large number of AIDs associated with non-TID2LM capable devices. In one example, the AP MLD 102 may determine one or more groups of non-AP MLDs 104 based on the AID associated with each of the non-AP MLDs 104. Here, the AP MLD 102 may group multiple TID2LM capable devices if the AIDs corresponding to the devices are relatively close. For example, the AP MLD 102 may transmit a TIM element indicating that buffered data is available to a first group of two TID2LM capable non-AP MLDs associated with AIDs 100 and 102, and a second group of two TID2LM capable non-AP MLDs associated with AIDs 1780 and 1782. In this example, there is a gap of 1678 AIDs between the first group and the second group. Thus, the AP MLD 102 may transmit the first MLTE 408, wherein the first MLTE 408 uses an AID offset of 100 and includes multi-link traffic bitmaps for devices with AIDs 100, 101, and 102. The AP MLD 102 may transmit the second MLTE 412, wherein the second MLTE 412 uses an AID offset of 1780 and includes multi-link traffic bitmaps for devices with AIDs 1780, 1781, and 1782. Accordingly, the non-AP MLDs 104 may monitor the multiple MLTEs until they find the MLTE with an AID offset with the corresponding link bitmap.

Thus, by transmitting multiple MLTEs, the AP MLD 102 refrains from transmitting multi-link traffic bitmaps for AIDs that correspond to non-TID2LM capable devices or TID2LM capable devices that do not have data buffered for them. As such, the MLTEs are smaller, which improves the efficiency of wireless spectrum use and reduces the overall airtime that the AP MLD 102 uses to transmit the link bitmaps. It should be noted that the multiple MLTEs 408/412 may be transmitted in the beacon frame 402 or in the subsequent frame 404. In either case, the use of multiple MLTEs 408/412 reduces beacon bloat relative to using a single MLTE that carries multi-link traffic bitmaps for each of the 1678 AIDs in the gap between the first group and the second group. In some examples, the TIM element 406, or any suitable field in the beacon frame 402, may include an indication for the non-AP MLDs 104 of whether multiple MLTE 408 will be transmitted in the beacon frame 402, in the subsequent frame 404, or both.

In some examples, the AP MLD 102 may transmit the TIM 406 and one or more MLTEs 408/412 via a downlink (DL) multi-unit (MU) PPDU. Generally, a PPDU includes multiple resource units (RUs), and each RU may include one or more frames. In this example, the AP MLD 102 may include an indication of which RU carries an MLTE, and which non-AP MLD 104 (e.g., AID offset) that MLTE corresponds to. For example, the indication may provide an AID or an STA ID associated with a particular RU that carries an MLTE so that the non-AP MLD 104 with that AID or STA ID will know which RU carries the MLTE that corresponds to it. For example, the AP MLD 102 may transmit an indication that all non-AP MLDs 104 having an AID or STA ID between 0 and 50 will have one or more MLTEs in a first RU. In some examples, the AP MLD 102 may use a group ID (e.g., STA ID or other unique identifier) in the indication to notify a group of non-AP MLDs 104 of a broadcast RU that includes an MLTE that applies to the whole group. In some examples, the AP MLD 102 may transmit the indication via a PHY header (or any other suitable field) of the PPDU. Accordingly, the non-AP MLD 104 may receive and decode the header and determine which RU it should monitor for the MLTE that will provide it with the link bitmap.

In some examples, the beacon frame 402 may include signaling bits for group-addressed data in an AP MLD. Separate bits other than bits in PVB in TIM element may be introduced to signal group addressed data in MLD context.

### Example Techniques for Decoupling the TIM from AID-Space

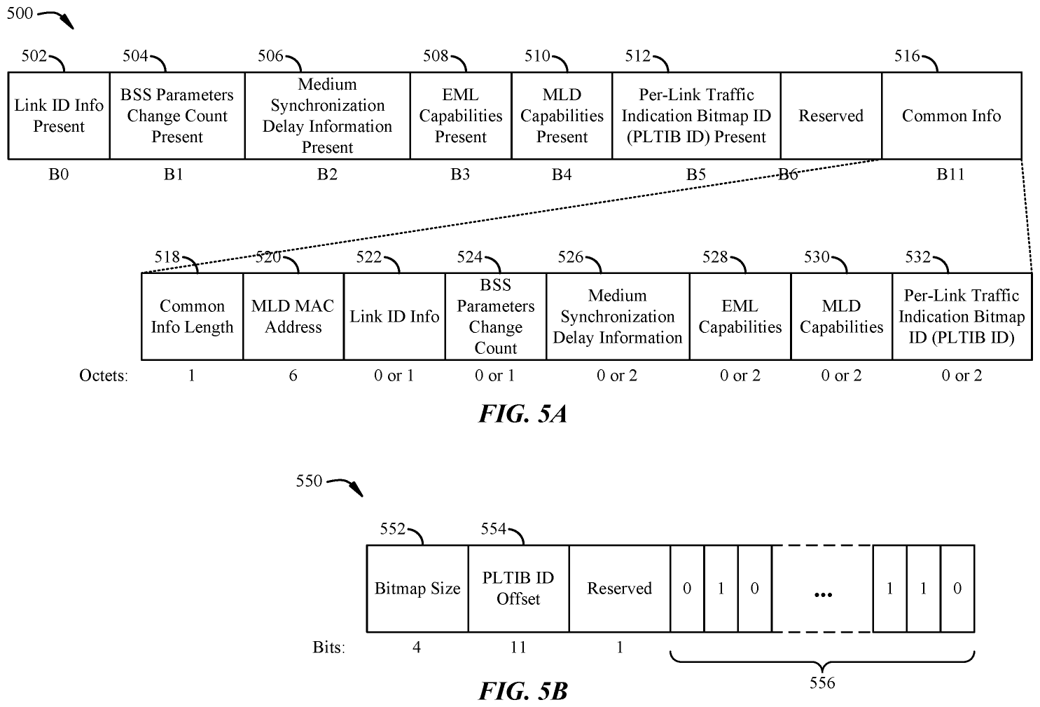

FIG. 5A is a block diagram illustrating an example multi-link element 500 that includes a non-legacy subfield that uses a PLTIB ID in addition to or as a replacement to an AID. The multi-link element 500 contains several “presence” elements, including link ID info present 502, BSS Parameters Change Count Present 504, Medium Synchronization Delay Information Present 506, EML Capabilities Present 508, MLD Capabilities Present 510, Per-Link Traffic Indication Bitmap ID (PLTIB ID) Present, and common info 516. The PLTIB ID present 512 element or subfield may also be a non-legacy subfield.

The common info 516 field may contain several subfields, including Common Info Length 518, MLD MAC Address 520, Link ID Info 522, BSS Parameters Change Count 524, Medium Synchronization Delay Information 526, EML Capabilities 528, MLD Capabilities 530, and the PLTIB ID subfield 532. The PLTIB ID may be carried in the 11 LSB s of the PLTIB ID subfield 532 of the common info 516 of the basic multi-link element 500. In some examples, the multi-link element 500 may be present in an association and/or re-association communication from an AP MLD to a non-AP MLD. In some examples, the 5 MSBs of the PLTIB ID subfield 532 may be kept reserved. The common info 516 may carry information common to all links of the AP MLD. Accordingly, during association between an AP MLD and a non-AP MLD, the AP MLD may use the common field to assign a new unique ID (e.g., PLTIB ID) to the associating non-AP MLD. In this manner, the AP MLD decouples the MLTE 550 from the PVB of the TIM element, and instead relied on the PLTIB ID. In some examples

FIG. 5B is a block diagram illustrating an example MLTE 550 at includes a non-legacy subfield called PLTIB ID Offset 554 that may be used instead of the AID offset 310 of the MLTE illustrated in FIG. 3. Here, the example MLTE 550 includes a bitmap size subfield 552, the PLTIB ID offset 554, and one or more per-link traffic indication bitmaps (e.g., PLTIFs 556). Accordingly, the AID offset of the MLTE 550 is modified to use a PLTIB ID offset associated with the PLTIB ID provided in the multi-link element 500. Accordingly, the non-AP MLD does not depend on the PVB of the TIM element, but instead depends on the new PLTIB ID and the PLTIB offset to determine its position, and which link it should wake up to in order to receive buffered data intended for it. In some examples, the PLTIB ID may be given only to STAs or non-AP MLDs that are TID2LM capable. In such an example, the TID2LM capable devices may be inherently grouped, thereby reducing the amount of time required to transmit associated PLTIFs 556.

In some examples, a TID2LM capable device may determine its corresponding bitmap among the PLTIFs 556 using a tuple defined by its own PLTIB ID and the PLTIB ID offset 554 of the MLTE 550. Thus, relative position of the TID2LM capable device among other PLTIB IDs and the PLTIB ID offset 554 may define the position of the devices' corresponding bitmap in the PLTIF 556.

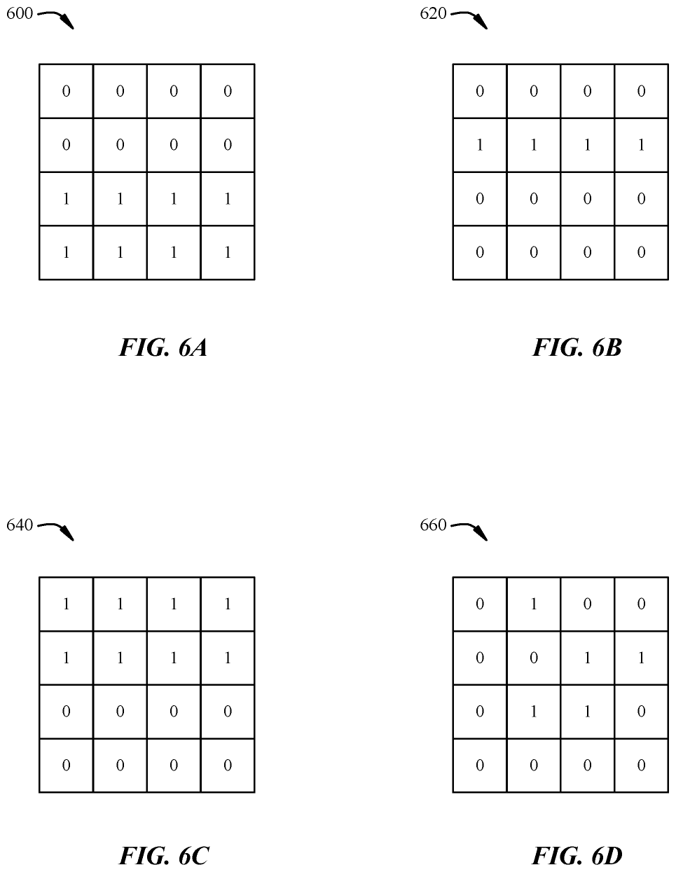

FIGS. 6A-6D are block diagrams conceptually illustrating four different scenarios where an AP MLD has buffered data for a subset of sixteen non-AP MLDs, each identified by a PLTIB ID. Each scenario is represented by a PLTIB ID layout in a grid form, wherein the top left square is associated with a smallest PLTIB ID value (e.g., 0), and wherein the PLTIB ID value increases in each successive square, ending at the bottom right square with the highest PLTIB ID value (e.g., 15).

FIG. 6A illustrates an example first PLTIB ID layout 600 wherein an AP MLD has no data for a first subset of non-AP MLDs (e.g., squares marked with a “0”; PLTIB IDs 0-7) but has buffered data for a second subset of non-AP MLDs (e.g., squares marked with a “1”; PLTIB IDs 8-15). In this example, the AP MLD may transmit the MLTE 550 of FIG. 5B with the PLTIB offset subfield 554 set to “8”, indicating that the following PLTIFs 556 will start with a bitmap intended for a non-AP MLD having PLTIB ID 8. Each subsequent PLTIF bitmap may then correspond to a subsequent non-AP MLD in sequence according to the respective PLTIB IDs. For example, the next bitmap may be intended for non-AP MLD having PLTIB ID 9, and the next bitmap may be intended for non-AP MLD having PLTIB ID 10, etc., to non-AP MLD having PLTIB ID 15. Thus, the PLTIF 556 may include eight bitmaps.

FIG. 6B illustrates an example second PLTIB ID layout 620 wherein an AP MLD has no data for a first subset of non-AP MLDs (e.g., squares marked with a “0”; PLTIB IDs 0-3 and 8-15) but has buffered data for a second subset of non-AP MLDs (e.g., squares marked with a “1”; PLTIB IDs 4-7). In this example, the PLTIB offset subfield 554 may be used to start the PLTIF bitmaps at a bitmap corresponding to PLTIB ID 4, but the bitmaps would include bitmaps for PLTIB IDs 8-15 as well, even though the AP MLD has not data to transmit to the non-AP MLDs associated with PLTIB IDs 8-15.

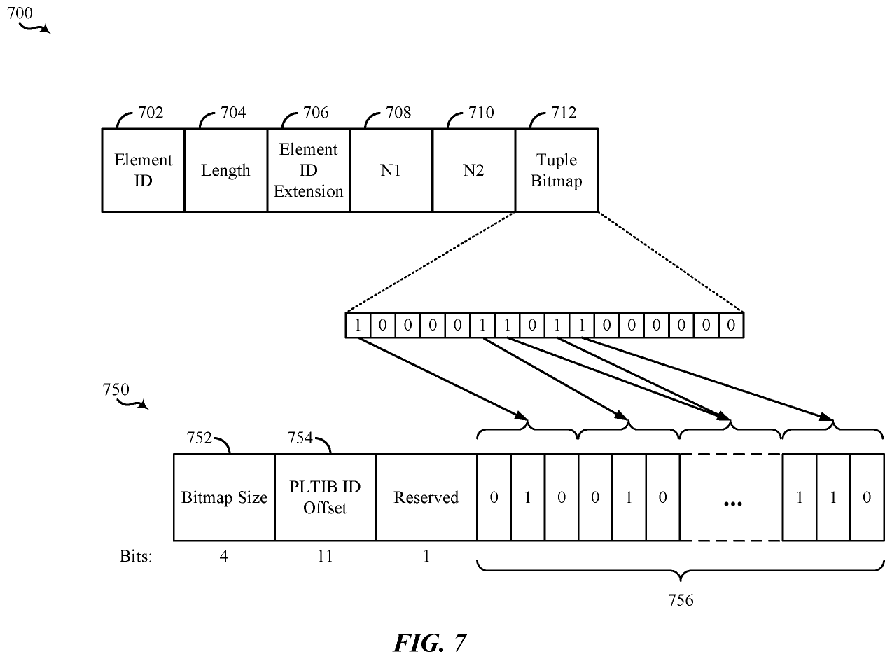

Thus, a non-legacy element (e.g., a non-legacy MLTE or a non-legacy element used in addition to the MLTE 550 of FIG. 5B) may be used by the AP MLD so that the MLTE is not required to include bitmaps for PLTIB IDs 8-15. One example of a non-legacy element is illustrated and described in FIG. 7. In some examples, the non-legacy element may include one or more fields providing a tuple of values (e.g., N1, N2) configured to indicate a first PLTIB ID for which the AP MLD has buffered data (e.g., PLTIB ID 4) and a last PLTIB ID for which the AP MLD has buffered data (e.g., PLTIB ID 7). As such, the tuple of values may indicate that the AP MLD has buffered data for non-AP MLDs associated with PLTIB IDs 4-7, without having to provide unnecessary link bitmaps for any of PLTIB IDs 0-3 and 8-15.

FIG. 6C illustrates an example third PLTIB ID layout 640 wherein an AP MLD has data buffered for a first subset of non-AP MLDs (e.g., squares marked with a “1”; PLTIB IDs 0-7) but has no buffered data for a second subset of non-AP MLDs (e.g., squares marked with a “0”; PLTIB IDs 8-15).

Thus, the non-legacy element may be used by the AP MLD so that the MLTE can include bitmaps for PLTIB IDs 0-7, but not PLTIB IDs 8-15. In this example, the non-legacy element may use the tuple of values configured to indicate a first PLTIB ID for which the AP MLD has buffered data (e.g., PLTIB ID 0) and a last PLTIB ID for which the AP MLD has buffered data (e.g., PLTIB ID 7). As such, the tuple of values may indicate that the AP MLD has buffered data for non-AP MLDs associated with PLTIB IDs 0-7, without having to provide unnecessary link bitmaps for any of PLTIB IDs 8-15.

FIG. 6D illustrates an example fourth PLTIB ID layout 660 wherein an AP MLD has data buffered for a first subset of non-AP MLDs (e.g., squares marked with a “1”; PLTIB IDs 1, 6, 7, 9, and 10) but has no buffered data for a second subset of non-AP MLDs (e.g., squares marked with a “0”; PLTIB IDs 0, 2-5, 8, and 11-15). In this example, the PLTIB offset subfield 554 may be used to start the PLTIF bitmaps at a bitmap corresponding to PLTIB ID 1, but the PLTIF would include bitmaps for PLTIB IDs 2-15 as well, even though the AP MLD has not data to transmit to the non-AP MLDs associated with all of PLTIB IDs 2-15.

Thus, the non-legacy element may be used by the AP MLD so that the MLTE can include bitmaps for PLTIB IDs 1, 6, 7, 9, and 10, but not PLTIB IDs 0, 2-5, 8, and 11-15. In this example, the non-legacy element may use multiple tuples configured to indicate each PLTIB ID for which the AP MLD has buffered data. Here, the AP MLD may choose to define a total of three tuples: (1,1), (6,7), and (9,10). As such, the tuple of values may indicate that the AP MLD has buffered data for non-AP MLDs associated with PLTIB IDs 1, 6, 7, 9, and 10, without having to provide unnecessary link bitmaps for any of PLTIB IDs 0, 3-5, 8, and 11-15.

FIG. 7 is a block diagram illustrating an example non-legacy element 700 for providing more information for offsetting bitmaps relative to an MLTE 750 (e.g., MLTE 550 of FIG. 5B). As described in FIGS. 6A-6D, solutions may vary for each example PLTIB ID layout. Thus, FIG. 7 is directed to a common solution may provide a more efficient approach to signaling buffered data and corresponding links.

Here, the non-legacy element 700 is configured to carry a pair of offsets (e.g., a tuple defined by N1 708 and N2 710). In this example, the non-legacy element 700 includes an element ID 702, an element length 704, an element extension ID 706, a first PLTIB ID (e.g., N1 708) for which the AP MLD has buffered data, and a last PLTIB ID (e.g., N2 710) for which the AP MLD has buffered data. It should be noted that the MLTE 750 may include a PLTIF 756 containing bitmaps sequentially corresponding to only the non-AP MLDs associated with the first PLTIB ID, the last PLTIB ID, and any PLTIB IDs in-between that are identified in the tuple bitmap 712. The size (n) of the tuple bitmap 712 may be defined as n=(N2−N1)+1, and the size of the PLTIF 756 may be defined as k(l+1), wherein k is the number of set bits in the tuple bitmap 712 and 1 is the number of links. Note that a tuple bitmap 712 of size n may occupy a total of (n+pad)/8 octets in the element 700 where a size (in bits) of the ‘pad’ may be defined by (n+pad) %8=0.

In some examples, the non-legacy element 700 may be an optional element for an AP MLD but a mandatory element for a non-AP MLD. That is, a non-AP MLD must be able to process the non-legacy element 700 if included in a beacon and/or probe-response frame transmitted by the AP MLD. For example, it may not be necessary to use the non-legacy element 700 for the case of the first PLTIB ID layout 600 of FIG. 6A because the PLTIB ID offset 754 is all that is needed to minimize the number of link bitmaps in the MLTE 750. That is, the PLTIB ID offset 754 may indicate that the PLTIF 756 starts at PLTIB 8 (e.g., the first “1” in the first PLTIB ID layout 600) and because data is buffered for each non-AP MLD thereafter, a last PLTIB ID is not necessary to bound the group.

Referring back to FIG. 6D, the fourth PLTIB ID layout 660 shows sixteen PLTIB IDs allocated to sixteen non-AP MLDs that are capable of TID2LM, wherein the AP MLD has buffered data for PLTIB IDs 2, 6, 7, 9, and 10 (e.g., layout entries with a “1”). As discussed above, three tuples may be used to isolate the PLTIB IDs and minimize the number of bitmaps in the PLTIF 756. However, the three tuples may occupy a large amount of space. Thus, in some examples, the non-legacy element 700 may include a tuple bitmap 712 subfield. Here, the non-legacy element 700 may still carry a tuple (e.g., N1 708 and N2 710) configured to indicate a first PLTIB ID and a last PLTIB ID, and the tuple bitmap may be configured to indicate which PLTIB IDs within the first PLTIB ID and the last PLTIB ID have buffered data.

Using the example fourth PLTIB ID layout 660 of FIG. 6D, the AP MLD may set N1 708 equal to 1 (e.g., the first PLTIB ID with buffered data) and set N2 710 equal to 10 (e.g., the last PLTIB ID with buffered data). Because there are eight PLTIB IDs between N1 and N2, the AP MLD may also set the tuple bitmap field such that each of the eight MSBs map to one of the eight PLTIB IDs between N1 and N2. In this example, the tuple bitmap 712 is shown as 1000011011000000, because the tuple bitmap 712 starts at N1 and the four PLTIB IDs following N1 do not have buffered data at the AP MLD. The next two PLTIB IDs (e.g., PLTIB 6 and PLTIB 7) have buffered data, the next PLTIB ID (e.g., PLTIB 8) does not have buffered data. The next two PLTIB IDs (e.g., PLTIB IDs 9 and 10, where PLTIB 10 is N2) have buffered data. In this example, the remaining six bits are set to “0” because the tuple bitmap 712 subfield may be a two-octet field. Thus, the remaining LSBs may be padded with “0.”

Accordingly, the AP MLD may transmit the non-legacy element 700 to the non-AP MLDs, and the non-AP MLDs may determine whether they have buffered data at the AP MLD by mapping their corresponding PLTIB ID with the tuple and tuple bitmap. If one or more non-AP MLDs have buffered data, they may use the bitmap corresponding to their PLTIB ID(s) in the PLTIF 756 to determine which link they need to wake up on in order to receive the buffered data. As illustrated in FIG. 7, each PLTIB ID that is indicated as a “1” in the tuple bitmap 712 sequentially corresponds to a 3-bit field in the PLTIF 756, wherein each bit of the 3-bit field corresponds to a particular link (e.g., 2.4 GHz, 5 GHz, 6 GHz) over which the non-AP MLD can receive the buffered data.

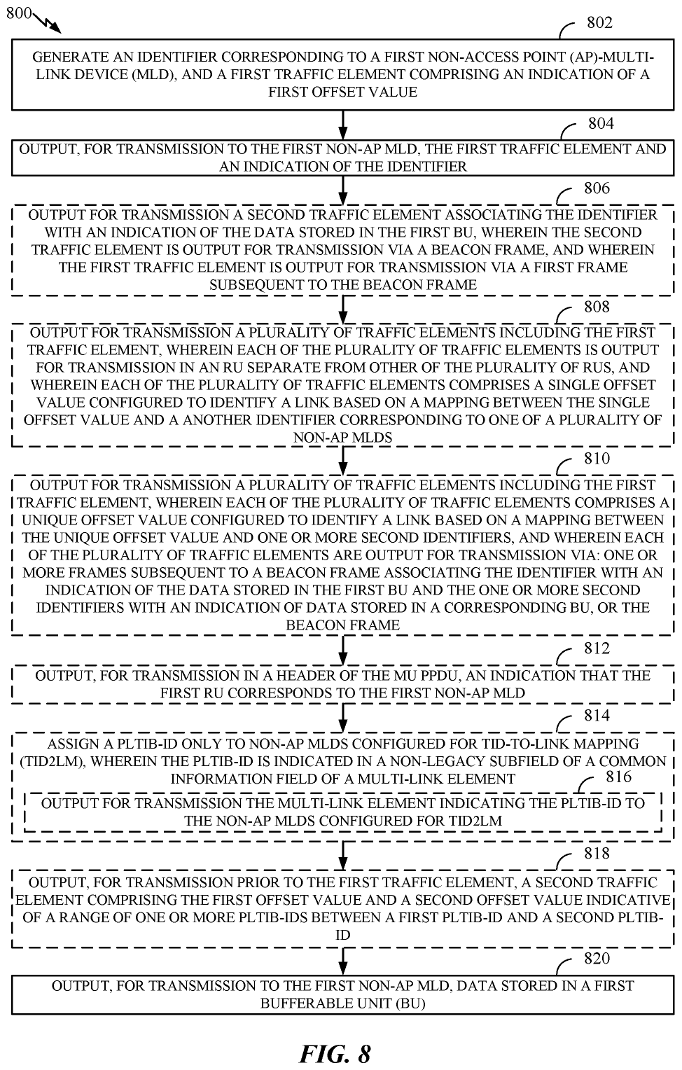

FIG. 8 is a flow diagram illustrating example operations 800 for wireless communication. The operations 800 may be performed, for example, by an AP MLD (e.g., such as the AP 102 of FIG. 1). The operations 800 may be implemented as software components that are executed and run on one or more processors (e.g., controller 230 of FIG. 2). Further, the transmission and reception of signals by the AP in operations 800 may be enabled, for example, by one or more antennas (e.g., antennas 224 of FIG. 2). In certain aspects, the transmission and/or reception of signals by the AP may be implemented via a bus interface of one or more processors (e.g., controller 230) obtaining and/or outputting signals.

The operations 800 begin, at a first block 802, by generating an identifier corresponding to a first non-access point (AP)-multi-link device (MLD), and a first traffic element comprising an indication of a first offset value. For example, the AP MLD may generate and assign an identifier (e.g., AID and/or PLTIB-ID) to a non-AP MLD (e.g., STA 104 of FIG. 1). The first traffic element may include an MLTE (e.g., MLTE in the third row 306 of FIG. 3, the MLTE 550 of FIG. 5B, or the MLTE 750 of FIG. 7). The MLTE may identify a first link based on the AID offset 310 or the PLTIB-ID offset 554/754 subfield and the identifier assigned to the non-AP MLD.

The operations 800 may proceed to a second block 804, by outputting, for transmission to the first non-AP MLD, the first traffic element and an indication of the identifier. Here, the AP MLD may provide the identifier to the non-AP MLD and the MLTE, however, they may be transmitted to the non-AP MLD in separate transmissions.

The operations 800 may optionally proceed to a third block 806, by outputting for transmission a second traffic element associating the identifier with an indication of the data stored in the first BU, wherein the second traffic element is output for transmission via a beacon frame, and wherein the first traffic element is output for transmission via a first frame subsequent to the beacon frame. Here, the second traffic element may be a TIM element (e.g., TIM element 406 of FIG. 4) or a non-legacy element (e.g., non-legacy element 700 of FIG. 7). The TIM element may be configured to provide a PVB indicative of whether a particular non-AP MLD has a multi-link traffic indication bitmap (e.g., a bitmap in a PLTIF of the MLTE), while the non-legacy element may be configured to provide one or more tuples and/or a tuple bitmap indicative of whether a particular non-AP MLD has a multi-link traffic indication bitmap. In other words, the second traffic element may provide the non-AP MLD with notice that the AP MLD has data buffered for it. In this example, the second traffic element is transmitted in a beacon frame prior to transmission of the MLTE, which is transmitted in a separate frame.

The operations 800 may optionally proceed to a fourth block 808, by outputting for transmission a plurality of traffic elements including the first traffic element, wherein each of the plurality of traffic elements is output for transmission in an RU separate from other of the plurality of RUs, and wherein each of the plurality of traffic elements comprises a single offset value configured to identify a link based on a mapping between the single offset value and a another identifier corresponding to one of a plurality of non-AP MLDs. For example, the AP MLD may transmit a single PPDU that has multiple RUs, wherein each RU has one or more frames. A PHY header of the PPDU may be configured to indicate which RU contains the MLTE that the non-AP MLD needs to parse. In this example, multiple MLTEs may be transmitted, where each MLTE is transmitted in a separate RU.

The operations 800 may optionally proceed to a fifth block 810, by outputting for transmission a plurality of traffic elements including the first traffic element, wherein each of the plurality of traffic elements comprises a unique offset value configured to identify a link based on a mapping between the unique offset value and one or more second identifiers, and wherein each of the plurality of traffic elements are output for transmission via: one or more frames subsequent to a beacon frame associating the identifier with an indication of the data stored in the first BU and the one or more second identifiers with an indication of data stored in a corresponding BU, or the beacon frame. In this example, the AP MLD may transmit multiple MLTEs, with each of the multiple MLTEs containing PLTIF bitmaps that correspond to different non-AP MLDs. Multiple MLTEs may be used if there is a large number of non-AP MLDs that do not have buffered data but do have sequential identifiers between non-AP MLDs that do have buffered data. This allows the MLTEs to be shorter so that they don't have to carry PLTIF bitmaps corresponding to the large number of non-AP MLDs that do not have buffered data.

The operations 800 may optionally proceed to a sixth block 812, by outputting, for transmission in a header of the MU PPDU, an indication that the first RU corresponds to the first non-AP MLD.

The operations 800 may optionally include a seventh block 814 directed to assigning a PLTIB-ID only to non-AP MLDs configured for TID-to-link mapping (TID2LM), wherein the PLTIB-ID is indicated in a non-legacy subfield of a common information field of a multi-link element.

The operations 800 may optionally include an eighth block 816 directed to outputting for transmission the multi-link element indicating the PLTIB-ID to the non-AP MLDs configured for TID2LM.

The operations 800 may optionally include a ninth block 818 directed to output, for transmission prior to the first traffic element, a second traffic element comprising the first offset value and a second offset value indicative of a range of one or more PLTIB-IDs between a first PLTIB-ID and a second PLTIB-ID.

The operations 800 may proceed to a tenth block 820 by outputting, for transmission to the first non-AP MLD, data stored in a first bufferable unit (BU). For example, the MLTE may carry a bitmap containing one or more “1” values. The position of the values may indicate a particular link over which the buffered data will be transmitted. Thus, if a particular position in the bitmap is a “1,” then the link corresponding to that position will carry the data.

In certain aspects, the indication of the first offset value is configured to identify a first link based on a mapping between the first offset value and the identifier, and the data stored in the first BU is output, for transmission to the first non-AP MLD, via the first link.

In certain aspects, the first traffic element comprises an indication of group addressed BUs for another link.

In certain aspects, the first frame is output for transmission to a group of non-AP MLDs including the first non-AP MLD.

In certain aspects, the first traffic element is configured to identify a plurality of links including the first link, and wherein each of the plurality of links is mapped to at least one of the non-AP MLDs in the group of non-AP MLDs.

In certain aspects, the beacon frame comprises an indication that the first traffic element is output for transmission in the first frame subsequent to the beacon frame.

In certain aspects, the first traffic element is output for transmission via a first resource unit (RU) of a multi-user (MU) physical layer protocol data unit (PPDU).

In certain aspects, the identifier is a per-link traffic indication bitmap identifier (PLTIB-ID), and wherein the operations 800 may proceed to assign a PLTIB-ID only to non-AP MLDs configured for TID-to-link mapping, wherein the PLTIB-ID is indicated in a non-legacy subfield of a common information field of a multi-link element, and output for transmission the multi-link element indicating the PLTIB-ID to the non-AP MLDs configured for TID-to-link mapping.

In certain aspects, the PLTIB-ID is assigned to non-AP MLDs configured for TID2LM.

In certain aspects, the operations 800 may include outputting, for transmission prior to the first traffic element, a second traffic element comprising the first offset value and a second offset value indicative of a range of one or more PLTIB-IDs between a first PLTIB-ID and a second PLTIB-ID.

In certain aspects, the first offset value and the second offset value are a first tuple, and wherein the second traffic element further comprises a plurality of tuples including the first tuple.

In certain aspects, at least one of: the second traffic element is a non-legacy element, the first offset value indicates a first PLTIB-ID corresponding to the data stored in the first BU intended for the first non-AP MLD, the second offset value indicates a second PLTIB-ID corresponding to data stored in a second BU intended for a second non-AP MLD, or the second traffic element further comprises a bitmap indicating whether data is stored in a third BU for a third non-AP MLD associated with a third PLTIB-ID within the range of the one or more PLTIB-IDs between the first PLTIB-ID and the second PLTIB-ID.

In certain aspects, at least one of: the first traffic element further comprises a first bitmap of one or more bitmaps, or the first bitmap is mapped to the first non-AP MLD via the first offset value, and the first bitmap is configured to identify the first link.

In certain aspects, the first traffic element is a multi-link traffic element (MLTE).

In certain aspects, the first traffic element further comprises a first bitmap of one or more bitmaps, and wherein the first bitmap is configured to identify the first link.

In certain aspects, the identifier is an association identifier (AID).

In certain aspects, the first link is signaled via a bitmap of the first traffic element.

In certain aspects, at least one of: the first link is determined based on one or more criteria, the one or more criteria include load balancing traffic parameters, or the first link is configured for uplink communications and downlink communications.

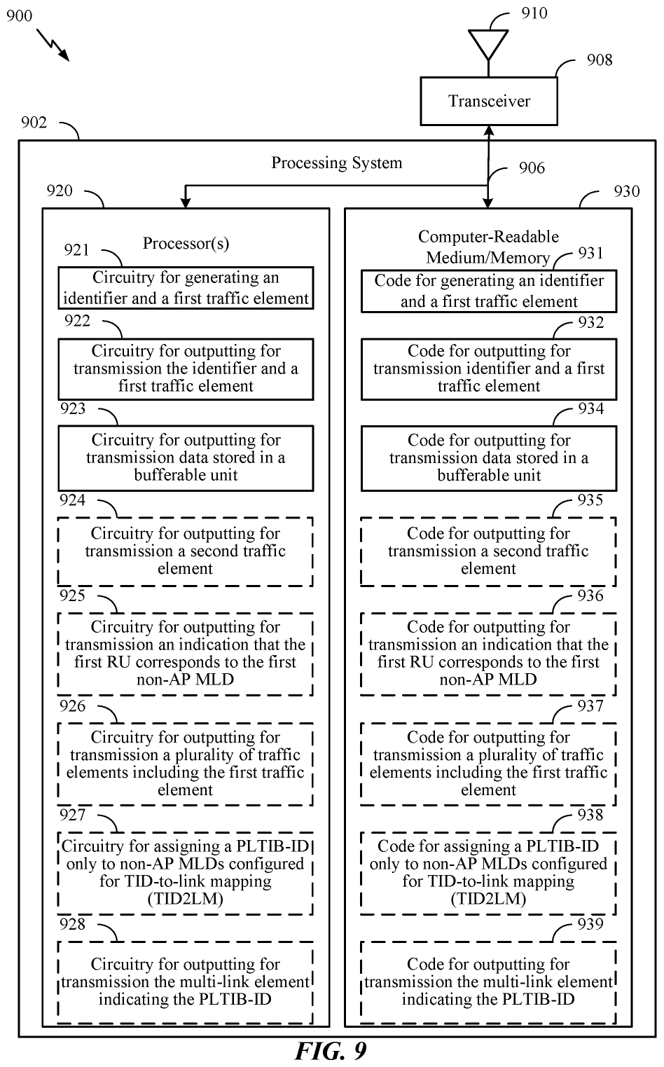

FIG. 9 depicts an example communications device 900 that includes various components operable, configured, or adapted to perform operations for the techniques disclosed herein, such as the operations depicted and described with respect to FIG. 8. In some examples, communication device 900 may be an AP MLD (e.g., AP 102) as described, for example with respect to FIGS. 1 and 2.

Communications device 900 includes a processing system 902 coupled to a transceiver 908 (e.g., a transmitter and/or a receiver). Transceiver 908 is configured to transmit (or send) and receive signals for the communications device 900 via an antenna 910, such as the various signals as described herein. Processing system 902 may be configured to perform processing functions for communications device 900, including processing signals received and/or to be transmitted by communications device 900.

Processing system 902 includes one or more processors 920 coupled to a computer-readable medium/memory 930 via a bus 906. In certain aspects, computer-readable medium/memory 930 is configured to store instructions (e.g., computer-executable code) that when executed by the one or more processors 920, cause the one or more processors 920 to perform the operations illustrated in FIG. 8, or other operations for performing the various techniques discussed herein.

In the depicted example, computer-readable medium/memory 930 stores code 931 for generating an identifier corresponding to a first non-access point (AP)-multi-link device (MLD), and a first traffic element comprising an indication of a first offset value; code 932 for outputting, for transmission to the first non-AP MLD, the first traffic element and an indication of the identifier; code 934 for outputting, for transmission to the first non-AP MLD, data stored in a first bufferable unit (BU); code 935 for outputting for transmission a second traffic element associating the identifier with an indication of the data stored in the first BU, wherein the second traffic element is output for transmission via a beacon frame, and wherein the first traffic element is output for transmission via a first frame subsequent to the beacon frame; code 936 for outputting, for transmission in a header of the MU PPDU, an indication that the first RU corresponds to the first non-AP MLD; code 937 for outputting for transmission a plurality of traffic elements including the first traffic element, wherein each of the plurality of traffic elements is output for transmission in an RU separate from other of the plurality of RUs, and wherein each of the plurality of traffic elements comprises a single offset value configured to identify a link based on a mapping between the single offset value and a another identifier corresponding to one of a plurality of non-AP MLDs; code 937 may also be configured for outputting for transmission a plurality of traffic elements including the first traffic element, wherein each of the plurality of traffic elements comprises a unique offset value configured to identify a link based on a mapping between the unique offset value and one or more second identifiers, and wherein each of the plurality of traffic elements are output for transmission via: one or more frames subsequent to a beacon frame associating the identifier with an indication of the data stored in the first BU and the one or more second identifiers with an indication of data stored in a corresponding BU, or the beacon frame; code 938 for assigning a PLTIB-ID only to non-AP MLDs configured for TID-to-link mapping (TID2LM), wherein the PLTIB-ID is indicated in a non-legacy subfield of a common information field of a multi-link element; code 939 for outputting for transmission the multi-link element indicating the PLTIB-ID to the non-AP MLDs configured for TID2LM; code 939 may also be configured for outputting, for transmission prior to the first traffic element, a second traffic element comprising the first offset value and a second offset value indicative of a range of one or more PLTIB-IDs between a first PLTIB-ID and a second PLTIB-ID.

In the depicted example, the one or more processors 920 include circuitry configured to implement the code stored in the computer-readable medium/memory 930, including circuitry 921 for generating an identifier corresponding to a first non-access point (AP)-multi-link device (MLD), and a first traffic element comprising an indication of a first offset value; circuitry 922 for outputting, for transmission to the first non-AP MLD, the first traffic element and an indication of the identifier; circuitry 923 for outputting, for transmission to the first non-AP MLD, data stored in a first bufferable unit (BU); circuitry 924 for outputting for transmission a second traffic element associating the identifier with an indication of the data stored in the first BU, wherein the second traffic element is output for transmission via a beacon frame, and wherein the first traffic element is output for transmission via a first frame subsequent to the beacon frame; circuitry 925 for outputting, for transmission in a header of the MU PPDU, an indication that the first RU corresponds to the first non-AP MLD; circuitry 926 for outputting for transmission a plurality of traffic elements including the first traffic element, wherein each of the plurality of traffic elements is output for transmission in an RU separate from other of the plurality of RUs, and wherein each of the plurality of traffic elements comprises a single offset value configured to identify a link based on a mapping between the single offset value and a another identifier corresponding to one of a plurality of non-AP MLDs; circuitry 926 may also be configured for outputting for transmission a plurality of traffic elements including the first traffic element, wherein each of the plurality of traffic elements comprises a unique offset value configured to identify a link based on a mapping between the unique offset value and one or more second identifiers, and wherein each of the plurality of traffic elements are output for transmission via: one or more frames subsequent to a beacon frame associating the identifier with an indication of the data stored in the first BU and the one or more second identifiers with an indication of data stored in a corresponding BU, or the beacon frame; circuitry 927 for assigning a PLTIB-ID only to non-AP MLDs configured for TID-to-link mapping (TID2LM), wherein the PLTIB-ID is indicated in a non-legacy subfield of a common information field of a multi-link element; circuitry 928 for outputting for transmission the multi-link element indicating the PLTIB-ID to the non-AP MLDs configured for TID2LM; circuitry 928 may also be configured for outputting, for transmission prior to the first traffic element, a second traffic element comprising the first offset value and a second offset value indicative of a range of one or more PLTIB-IDs between a first PLTIB-ID and a second PLTIB-ID.

Various components of communications device 900 may provide means for performing the methods described herein, including with respect to FIG. 8. In some examples, means for transmitting, outputting, or sending (or means for outputting for transmission) may include the transceivers 222 and/or antenna(s) 224 of the AP 102 illustrated in FIG. 2 and/or transceiver 908 and antenna 910 of the communication device 900 in FIG. 9. Means for determining, generating, assigning, mapping may include the controller 230, memory 232, and other various processors of FIG. 2 and/or the processor(s) 920 and computer-readable medium 930 of FIG. 9.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2. Notably, FIG. 9 is an example, and many other examples and configurations of communication device 900 are possible.

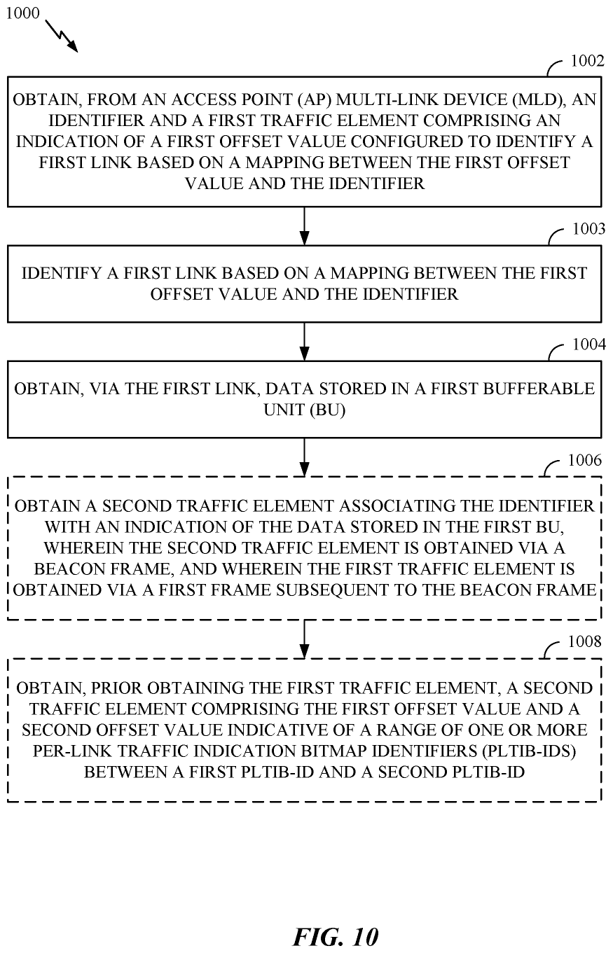

FIG. 10 is a flow diagram illustrating example operations 1000 for wireless communication, in accordance with certain aspects of the present disclosure. The operations 1000 may be performed, for example, by a non-AP MLD (e.g., STA 104 of FIG. 1). The operations 1000 may be implemented as software components that are executed and run on one or more processors (e.g., controller 280 of FIG. 2). Further, the transmission and reception of signals by the STA in operations 1000 may be enabled, for example, by one or more antennas (e.g., antennas 252 of FIG. 2). In certain aspects, the transmission and/or reception of signals by the STA may be implemented via a bus interface of one or more processors (e.g., controller 280) obtaining and/or outputting signals.

The operations 1000 begin, at a first block 1002, by obtaining, from an access point (AP) multi-link device (MLD), an identifier and a first traffic element comprising an indication of a first offset value.

The operations 1000 may proceed, at a second block 1003, by identifying a first link based on a mapping between the first offset value and the identifier.

The operations 1000 may proceed, at a third block 1004, by obtaining, via the first link, data stored in a first bufferable unit (BU).

The operations 1000 may optionally include a fourth block 1006, for obtaining a second traffic element associating the identifier with an indication of the data stored in the first BU, wherein the second traffic element is obtained via a beacon frame, and wherein the first traffic element is obtained via a first frame subsequent to the beacon frame.

The operations 1000 may optionally include a fifth block 1008, for obtaining, prior obtaining the first traffic element, a second traffic element comprising the first offset value and a second offset value indicative of a range of one or more per-link traffic indication bitmap identifiers (PLTIB-IDs) between a first PLTIB-ID and a second PLTIB-ID.

In certain aspects, at least one of: the second traffic element is a non-legacy element, or the apparatus is a first apparatus, the first offset value indicates a first PLTIB-ID corresponding to the data stored in the first BU intended for the first apparatus, the second offset value indicates a second PLTIB-ID corresponding to data stored in a second BU intended for a second apparatus, and the second traffic element further comprises a bitmap indicating whether data is stored in a third BU for a third apparatus associated with a third PLTIB-ID within the range of the one or more PLTIB-IDs between the first PLTIB-ID and the second PLTIB-ID.

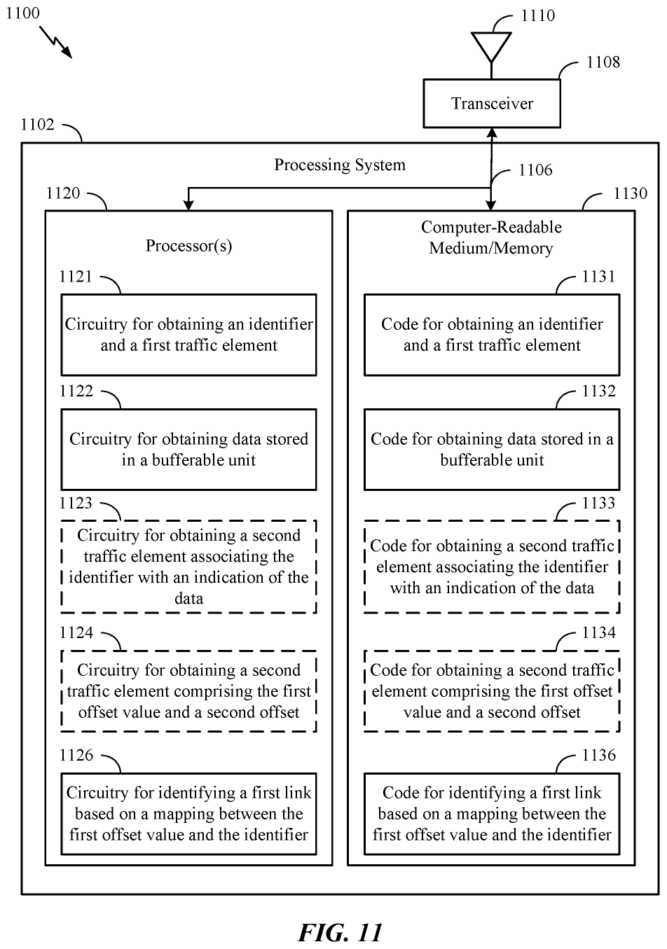

FIG. 11 depicts an example communications device 1100 that includes various components operable, configured, or adapted to perform operations for the techniques disclosed herein, such as the operations depicted and described with respect to FIG. 10. In some examples, communication device 1100 may be an non-AP MLD 104 as described, for example with respect to FIGS. 1 and 2.

Communications device 1100 includes a processing system 1102 coupled to a transceiver 1108 (e.g., a transmitter and/or a receiver). Transceiver 1108 is configured to transmit (or send) and receive signals for the communications device 1100 via an antenna 1110, such as the various signals as described herein. Processing system 1102 may be configured to perform processing functions for communications device 1100, including processing signals received and/or to be transmitted by communications device 1100.

Processing system 1102 includes one or more processors 1120 coupled to a computer-readable medium/memory 1130 via a bus 1106. In certain aspects, computer-readable medium/memory 1130 is configured to store instructions (e.g., computer-executable code) that when executed by the one or more processors 1120, cause the one or more processors 1120 to perform the operations illustrated in FIG. 11, or other operations for performing the various techniques discussed herein.

In the depicted example, computer-readable medium/memory 1130 stores code 1131 for obtaining, from an access point (AP) multi-link device (MLD), an identifier and a first traffic element comprising an indication of a first offset value; code 1132 for obtaining, via the first link, data stored in a first bufferable unit (BU); code 1133 for obtaining a second traffic element associating the identifier with an indication of the data stored in the first BU, wherein the second traffic element is obtained via a beacon frame, and wherein the first traffic element is obtained via a first frame subsequent to the beacon frame; code 1134 for obtaining, prior obtaining the first traffic element, a second traffic element comprising the first offset value and a second offset value indicative of a range of one or more per-link traffic indication bitmap identifiers (PLTIB-IDs) between a first PLTIB-ID and a second PLTIB-ID; and code 1136 for identifying a first link based on a mapping between the first offset value and the identifier.

In the depicted example, the one or more processors 1120 include circuitry configured to implement the code stored in the computer-readable medium/memory 1130, including circuitry 1121 for obtaining, from an access point (AP) multi-link device (MLD), an identifier and a first traffic element comprising an indication of a first offset value; circuitry 1122 for obtaining, via the first link, data stored in a first bufferable unit (BU); circuitry 1123 for obtaining a second traffic element associating the identifier with an indication of the data stored in the first BU, wherein the second traffic element is obtained via a beacon frame, and wherein the first traffic element is obtained via a first frame subsequent to the beacon frame; circuitry 1124 for obtaining, prior obtaining the first traffic element, a second traffic element comprising the first offset value and a second offset value indicative of a range of one or more per-link traffic indication bitmap identifiers (PLTIB-IDs) between a first PLTIB-ID and a second PLTIB-ID; and circuitry 1126 for identifying a first link based on a mapping between the first offset value and the identifier.

Various components of communications device 1100 may provide means for performing the methods described herein, including with respect to FIG. 13. In some examples, means for receiving (or means for obtaining) may include the transceivers 254 and/or antenna(s) 252 of the STA illustrated in FIG. 2 and/or transceiver 1108 and antenna 1110 of the communication device 1100 in FIG. 11. Means for identifying may include the controller 280, memory 282, and other various processors of FIG. 2 and/or the processor(s) 1120 and computer-readable medium 1130 of FIG. 11.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2. Notably, FIG. 11 is an example, and many other examples and configurations of communication device 1100 are possible.

### EXAMPLE ASPECTS

Example 1 is a method for wireless communications by an access point (AP), comprising: generating an identifier corresponding to a first non-AP multi-link device (MLD), and a first traffic element comprising an indication of a first offset value; outputting, for transmission to the first non-AP MLD, the first traffic element and an indication of the identifier; and outputting, for transmission to the first non-AP MLD, data stored in a first bufferable unit (BU).

Example 2 is the method of example 1, further comprising: outputting for transmission a second traffic element associating the identifier with an indication of the data stored in the first BU, wherein the second traffic element is output for transmission via a beacon frame, and wherein the first traffic element is output for transmission via a first frame subsequent to the beacon frame.

Example 3 is the method of any of examples 1 and 2, wherein the first traffic element comprises an indication of group addressed BUs for another link.

Example 4 is the method of example 2, wherein the first frame is output for transmission to a group of non-AP MLDs including the first non-AP MLD.

Example 5 is the method of example 4, wherein the first traffic element is configured to identify a plurality of links including the first link, and wherein each of the plurality of links is mapped to at least one of the non-AP MLDs in the group of non-AP MLDs.

Example 6 is the method of any of examples 2 and 3, wherein the beacon frame comprises an indication that the first traffic element is output for transmission in the first frame subsequent to the beacon frame.

Example 7 is the method of any of examples 1-6, wherein the first traffic element is output for transmission via a first resource unit (RU) of a multi-user (MU) physical layer protocol data unit (PPDU).

Example 8 is the method of example 7, further comprising: outputting, for transmission in a header of the MU PPDU, an indication that the first RU corresponds to the first non-AP MLD.

Example 9 is the method of any of examples 7 and 8, wherein the MU PPDU comprises a plurality of RUs including the first RU, and wherein the method further comprises: outputting for transmission a plurality of traffic elements including the first traffic element, wherein each of the plurality of traffic elements is output for transmission in an RU separate from other of the plurality of RUs, and wherein each of the plurality of traffic elements comprises a single offset value configured to identify a link based on a mapping between the single offset value and a another identifier corresponding to one of a plurality of non-AP MLDs.

Example 10 is the method of any of examples 1-9, further comprising: outputting for transmission a plurality of traffic elements including the first traffic element, wherein each of the plurality of traffic elements comprises a unique offset value configured to identify a link based on a mapping between the unique offset value and one or more second identifiers, and wherein each of the plurality of traffic elements are output for transmission via: one or more frames subsequent to a beacon frame associating the identifier with an indication of the data stored in the first BU and the one or more second identifiers with an indication of data stored in a corresponding BU, or the beacon frame.

Example 11 is the method of any of examples 1-10, wherein the identifier is a per-link traffic indication bitmap identifier (PLTIB-ID), and wherein the method further comprises: assigning a PLTIB-ID only to non-AP MLDs configured for TID-to-link mapping (TID2LM), wherein the PLTIB-ID is indicated in a non-legacy subfield of a common information field of a multi-link element; and outputting for transmission the multi-link element indicating the PLTIB-ID to the non-AP MLDs configured for TID2LM.

Example 12 is the method of example 11, wherein the PLTIB-ID is assigned to non-AP MLDs configured for TID2LM.

Example 13 is the method of example 11, wherein the first offset value indicates a PLTIB-ID offset.

Example 14 is the method of any of examples 1-13, further comprising: outputting, for transmission prior to the first traffic element, a second traffic element comprising the first offset value and a second offset value indicative of a range of one or more PLTIB-IDs between a first PLTIB-ID and a second PLTIB-ID.

Example 15 is the method of example 14, wherein the first offset value and the second offset value are a first tuple, and wherein the second traffic element further comprises a plurality of tuples including the first tuple.

Example 16 is the method of example 14, wherein, at least one of: the second traffic element is a non-legacy element, or the first offset value indicates a first PLTIB-ID corresponding to the data stored in the first BU intended for the first non-AP MLD, the second offset value indicates a second PLTIB-ID corresponding to data stored in a second BU intended for a second non-AP MLD, or the second traffic element further comprises a bitmap indicating whether data is stored in a third BU for a third non-AP MLD associated with a third PLTIB-ID within the range of the one or more PLTIB-IDs between the first PLTIB-ID and the second PLTIB-ID.

Example 17 is the method of example 14, wherein, at least one of: the first traffic element further comprises a first bitmap of one or more bitmaps, or the first bitmap is mapped to the first non-AP MLD via the first offset value, and the first bitmap is configured to identify the first link.

Example 18 is the method of any of examples 1-17, wherein the first traffic element is a multi-link traffic element (MLTE).

Example 19 is the method of any of examples 1-18, wherein the first traffic element further comprises a first bitmap of one or more bitmaps, and wherein the first bitmap is configured to identify the first link.

Example 20 is the method of any of examples 1-19, wherein the identifier is an association identifier (AID).

Example 21 is the method of any of examples 1-20, wherein the first link is signaled via a bitmap of the first traffic element.

Example 22 is the method of any of examples 1-21, wherein, at least one of: the first link is determined based on one or more criteria, the one or more criteria include load balancing traffic parameters, or the first link is configured for uplink communications and downlink communications.

Example 23 is the method of any of examples 1-22, wherein the indication of the first offset value is configured to identify a first link based on a mapping between the first offset value and the identifier, and wherein the data stored in the first BU is output, for transmission to the first non-AP MLD, via the first link.

Example 24 is a method for wireless communications at a non-access point (AP) multi-link device (MLD), comprising: obtaining, from an AP MLD, an identifier and a first traffic element comprising an indication of a first offset value; identifying a first link based on a mapping between the first offset value and the identifier; and obtaining, via the first link, data stored in a first bufferable unit (BU).

Example 25 is the method of example 24, further comprising: obtaining a second traffic element associating the identifier with an indication of the data stored in the first BU, wherein the second traffic element is obtained via a beacon frame, and wherein the first traffic element is obtained via a first frame subsequent to the beacon frame.

Example 26 is the method of any of examples 24 and 25, further comprising: obtaining, prior obtaining the first traffic element, a second traffic element comprising the first offset value and a second offset value indicative of a range of one or more per-link traffic indication bitmap identifiers (PLTIB-IDs) between a first PLTIB-ID and a second PLTIB-ID.

Example 27 is the method of any of examples 24-26, wherein, at least one of: the second traffic element is a non-legacy element, the non-AP MLD is a first non-AP MLD, the first offset value indicates a first PLTIB-ID corresponding to the data stored in the first BU intended for the first non-AP MLD, the second offset value indicates a second PLTIB-ID corresponding to data stored in a second BU intended for a second non-AP MLD, or the second traffic element further comprises a bitmap indicating whether data is stored in a third BU for a third non-AP MLD associated with a third PLTIB-ID within the range of the one or more PLTIB-IDs between the first PLTIB-ID and the second PLTIB-ID.

Example 28 is an apparatus for wireless communications, comprising means for performing a method in accordance with any one of examples 1-23.

Example 29 is an apparatus for wireless communications, comprising means for performing a method in accordance with any one of examples 24-27.

Example 30 is a non-transitory computer-readable medium comprising instructions that, when executed by an apparatus, causes the apparatus to perform a method in accordance with any one of examples 1-23.

Example 31 is a non-transitory computer-readable medium comprising instructions that, when executed by an apparatus, cause the apparatus to perform a method in accordance with any one of examples 24-27.

Example 32 is an apparatus for wireless communications, comprising: a memory comprising instructions; and one or more processors configured to execute the instructions to cause the apparatus to perform a method in accordance with any one of examples 1-23.

Example 33 is apparatus for wireless communications, comprising: a memory comprising instructions; and one or more processors configured to execute the instructions to cause the apparatus to perform a method in accordance with any one of examples 24-27.

### ADDITIONAL CONSIDERATIONS

The preceding description provides examples of techniques for increasing local area network (LAN) device privacy in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising:
a memory comprising instructions; and
one or more processors configured to execute the instructions and cause the apparatus to:
generate an identifier corresponding to a first non-access point (AP) multi-link device (MLD), and a first traffic element comprising an indication of a first offset value;
output, for transmission to the first non-AP MLD, the first traffic element and an indication of the identifier; and
output, for transmission to the first non-AP MLD, data stored in a first bufferable unit (BU).

2. The apparatus of claim 1, wherein the one or more processors are further configured to cause the apparatus to:
output for transmission a second traffic element associating the identifier with an indication of the data stored in the first BU, wherein the second traffic element is output for transmission via a beacon frame, and wherein the first traffic element is output for transmission via a first frame subsequent to the beacon frame.

3. The apparatus of claim 1, wherein the first traffic element comprises an indication of group addressed BUs for another link.

4. The apparatus of claim 2, wherein the first frame is output for transmission to a group of non-AP MLDs including the first non-AP MLD.

5. The apparatus of claim 4, wherein the first traffic element is configured to identify a plurality of links, and wherein each of the plurality of links is mapped to at least one of the non-AP MLDs in the group of non-AP MLDs.

6. The apparatus of claim 2, wherein the beacon frame comprises an indication that the first traffic element is output for transmission in the first frame subsequent to the beacon frame.

7. The apparatus of claim 1, wherein the first traffic element is output for transmission via a first resource unit (RU) of a multi-user (MU) physical layer protocol data unit (PPDU).

8. The apparatus of claim 7, wherein the one or more processors are further configured to cause the apparatus to:
output, for transmission in a header of the MU PPDU, an indication that the first RU corresponds to the first non-AP MLD.

9. The apparatus of claim 7, wherein the MU PPDU comprises a plurality of RUs including the first RU, and wherein the one or more processors are further configured to cause the apparatus to:
output for transmission a plurality of traffic elements including the first traffic element, wherein each of the plurality of traffic elements is output for transmission in an RU separate from other of the plurality of RUs, and wherein each of the plurality of traffic elements comprises a single offset value configured to identify a link based on a mapping between the single offset value and another identifier corresponding to one of a plurality of non-AP MLDs.

10. The apparatus of claim 1, wherein the one or more processors are further configured to cause the apparatus to:
output for transmission a plurality of traffic elements including the first traffic element, wherein each of the plurality of traffic elements comprises a unique offset value configured to identify a link based on a mapping between the unique offset value and one or more second identifiers, and wherein each of the plurality of traffic elements are output for transmission via:
one or more frames subsequent to a beacon frame associating the identifier with an indication of the data stored in the first BU and the one or more second identifiers with an indication of data stored in a corresponding BU, or
the beacon frame.

11. The apparatus of claim 1, wherein the identifier is a per-link traffic indication bitmap identifier (PLTIB-ID), and wherein the one or more processors are further configured to cause the apparatus to:
assign a PLTIB-ID only to non-AP MLDs configured for TID-to-link mapping (TID2LM), wherein the PLTIB-ID is indicated in a non-legacy subfield of a common information field of a multi-link element; and
output for transmission the multi-link element indicating the PLTIB-ID to the non-AP MLDs configured for TID2LM.

12. The apparatus of claim 11, wherein the PLTIB-ID is assigned to non-AP MLDs configured for TID2LM.

13. The apparatus of claim 11, wherein the first offset value indicates a PLTIB-ID offset.

14. The apparatus of claim 1, wherein the one or more processors are further configured to cause the apparatus to:
output, for transmission prior to the first traffic element, a second traffic element comprising the first offset value and a second offset value indicative of a range of one or more PLTIB-IDs between a first PLTIB-ID and a second PLTIB-ID.

15. The apparatus of claim 14, wherein the first offset value and the second offset value are a first tuple, and wherein the second traffic element further comprises a plurality of tuples including the first tuple.

16. The apparatus of claim 14, wherein, at least one of:
the second traffic element is a non-legacy element,
the first offset value indicates a first PLTIB-ID corresponding to the data stored in the first BU intended for the first non-AP MLD,
the second offset value indicates a second PLTIB-ID corresponding to data stored in a second BU intended for a second non-AP MLD, or
the second traffic element further comprises a bitmap indicating whether data is stored in a third BU for a third non-AP MLD associated with a third PLTIB-ID within the range of the one or more PLTIB-IDs between the first PLTIB-ID and the second PLTIB-ID.

17. The apparatus of claim 14, wherein, at least one of:
the first traffic element further comprises a first bitmap of one or more bitmaps, or
the first bitmap is mapped to the first non-AP MLD via the first offset value, and the first bitmap is configured to identify a link carrying the data stored in the BU.

18. The apparatus of claim 1, wherein the first traffic element is a multi-link traffic element (MLTE).

19. The apparatus of claim 1, wherein the first traffic element further comprises a first bitmap of one or more bitmaps, and wherein the first bitmap is configured to identify a link carrying the data stored in the BU.

20. The apparatus of claim 1, wherein the identifier is an association identifier (AID).

21. The apparatus of claim 1, wherein a link carrying the data stored in the BU is signaled via a bitmap of the first traffic element.

22. The apparatus of claim 1, wherein, at least one of:
a link carrying the data stored in the BU is determined based on one or more criteria,
the one or more criteria include load balancing traffic parameters, or
the link is configured for uplink communications and downlink communications.

23. The apparatus of claim 1, further comprising a transceiver configured to:
transmit, to the first non-AP MLD, the indication of the identifier and the first traffic element; and
transmit, to the first non-AP MLD, the data stored in the first BU, wherein the apparatus is configured as an access point (AP).

24. The apparatus of claim 1, wherein the indication of the first offset value is configured to identify a first link based on a mapping between the first offset value and the identifier, and wherein the data stored in the first BU is output, for transmission to the first non-AP MLD, via the first link.

25. An apparatus for wireless communications, comprising:
a memory comprising instructions; and
one or more processors configured to execute the instructions and cause the apparatus to:
obtain, from an access point (AP) multi-link device (MLD), an identifier and a first traffic element comprising an indication of a first offset value;
identify a first link based on a mapping between the first offset value and the identifier; and
obtain, via the first link, data stored in a first bufferable unit (BU).

26. The apparatus of claim 25, wherein the one or more processors are further configured to cause the apparatus to:
obtain a second traffic element associating the identifier with an indication of the data stored in the first BU, wherein the second traffic element is obtained via a beacon frame, and wherein the first traffic element is obtained via a first frame subsequent to the beacon frame.

27. The apparatus of claim 25, wherein the one or more processors are further configured to cause the apparatus to:
obtain, prior obtaining the first traffic element, a second traffic element comprising the first offset value and a second offset value indicative of a range of one or more per-link traffic indication bitmap identifiers (PLTIB-IDs) between a first PLTIB-ID and a second PLTIB-ID.

28. The apparatus of claim 27, wherein, at least one of:
the second traffic element is a non-legacy element, or
the apparatus is a first apparatus,
the first offset value indicates a first PLTIB-ID corresponding to the data stored in the first BU intended for the first apparatus,
the second offset value indicates a second PLTIB-ID corresponding to data stored in a second BU intended for a second apparatus, and the second traffic element further comprises a bitmap indicating whether data is stored in a third BU for a third apparatus associated with a third PLTIB-ID within the range of the one or more PLTIB-IDs between the first PLTIB-ID and the second PLTIB-ID.

29. The apparatus of claim 25, further comprising a transceiver configured to:
receive the identifier and the first traffic element; and
receive the data stored in the first BU, wherein the apparatus is configured as a non-AP MLD.

30. A method for wireless communications by an access point (AP) multi-link device (MLD), comprising:
generating an identifier corresponding to a first non-AP MLD, and a first traffic element comprising an indication of a first offset value;
outputting, for transmission to the first non-AP MLD, the first traffic element and an indication of the identifier; and
outputting, for transmission to the first non-AP MLD, data stored in a first bufferable unit (BU).
